(19) United States
(12) Patent Application Publication
(10) Pub. No.: US 2003/0124230 A1
(43) Pub. Date: Jul. 3, 2003

(54) Methods and products for bad breath

(76) Inventor: Jan Zielinski, Vista, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/310,430

(22) Filed: Dec. 4, 2002

Related U.S. Application Data
(60) Provisional application No. 60/366,378, filed on Mar. 20, 2002.

(30) Foreign Application Priority Data
Jun. 1, 2001 (WO) PCT/US01/17863

(51) Int. Cl. C12C 1/027

(52) U.S. Cl. 426/106

(57) ABSTRACT

A food product includes at least silymarin, betaine, or a combination thereof, and one of an antioxidant, glutathione, a methyl group donor, a sulfur group donor, acetyl CoA, or glucuronic acid in an amount effective to significantly reduce bad breath. Especially preferred food products include significant quantities of silymarin and betaine. The food product is advantageously advertised as reducing bad breath, improving liver function, digestion, and/or periodontal health. Contemplated food products include animal treats, and especially dog biscuits or other treats.

This application claims the benefit of International application PCT/US01/17863, which was filed Jun. 1, 2001 and of U.S. provisional application 60/366378, which was filed on Mar. 20, 2002, which is incorporated by reference herein.

### FIELD OF THE INVENTION

The field of the invention is food products and related methods.

### BACKGROUND OF THE INVENTION

Bad breath is unfortunately relatively common among humans and animals, and may be caused by various factors including certain types of food, inability to properly digest, and periodontal diseases.

There are numerous products and procedures available for humans suffering from bad breath. Several categories are known, including products that mask the odor, mouthwash to reduce germs in the mouth, and antibiotics for treatment of periodontal infections. However, these products and procedures are often ineffective, painful, and/or expensive. For example, breath mints and flavored chewing gum mask the bad breath without eliminating the cause of bad breath. Similarly, most mouthwashes provide only temporary relief. On the other hand, antibiotics eliminate with relatively high efficiency of at least some of the odor-generating agents, but are typically relatively expensive and may even lead to adverse side effects (e.g., generation of resistant strains, allergic reactions, etc.). Alternatively, surgery may be indicated to help people properly masticate and digest food.

Besides the products and procedures available for use in humans, there are also various products known in the art to reduce bad breath in canines. For example, such products include hard biscuits or raw bones that help remove plaque, or tablets containing natural or synthetic flavors. However, most of these products tend to be ineffective in reducing bad breath for lengthy periods of time. Raw bones and biscuits frequently fail to remove plaque effectively, and as a result dogs still have bad breath. Similarly, tablets merely mask the smells, providing only temporary relief for a dog's bad breath.

Although there are many methods and products known in the art to reduce bad breath, all or almost all of them suffer from one or more disadvantages. Therefore, there is still a need for improved products and methods to reduce or eliminate bad breath in humans and animals.

### SUMMARY OF THE INVENTION

The present invention is directed to foods that treat bad breath, and methods of advertising such foods.

The focus is on foods as opposed to pills or vitamin preparations. Preferred foods provide at least 10% of daily caloric intake per serving, and at least 10 mg of particular nutritional substances per kg of body weight of an individual (e.g., a human or a pet). The nutritional substances in such foods are present in a single serving size in an amount effective to reduce volatile sulfur compounds in the breath, preferably by at least 10% to 75%. In a further aspect, the foods are marketed specifically as treating bad breath.

Preferred nutritional substances include silymarin, antioxidants, glutathione, methyl group donors, sulfur group donors, acetyl CoA, and glucuronic acid. Contemplated antioxidants are ascorbic acid, alpha-tocopherol, astaxanthin, beta-carotene, and a green tea extract. Contemplated methyl group donors include betaine and S-adenosylmethionine. Contemplated sulfur group donors include methionine, cysteine, taurine, ethanethiosulfate, and sodium thiosulfate.

Various objects, features, aspects and advantages of the present invention will become more apparent from the following detailed description of preferred embodiments of the invention.

### DETAILED DESCRIPTION

The present inventors have discovered that bad breath in an individual can be effectively treated by including a relatively high concentration of one or more active ingredients in a serving of food. More particularly, the inventors contemplate that a food product can advantageously be supplemented with one or more of the following active ingredients: silymarin, an antioxidant, glutathione, a methyl group donor, a sulfur group donor, acetyl CoA, and glucuronic acid. The active ingredient is preferably present in a serving size of the food in an amount effective to reduce volatile sulfur compounds in breath of an individual in an amount of at least 10% when the serving size is administered to the individual.

While not wishing to be bound by any particular theory or mechanism, the inventors contemplate that the ingredient in contemplated products and food servings stimulates the detoxification process in the liver of the animal to which contemplated products and food servings are administered, and thereby decrease the amount of odor-forming volatile compounds, and especially of contemplated VSCs.

The liver is, among many other functions, thought to play three major roles in detoxification of various compounds. First, the liver filters blood to clear bacteria and other toxins from blood before the blood re-enters the general circulation. Second, the liver produces and secretes bile, which serves among other functions to carry many toxic substances to the intestines where they may be absorbed by fiber and excreted. Third, the liver enzymatically modifies various compounds (and especially toxins) through a two-step process, referred to as phase I and phase II.

Phase I enzymes are thought to neutralize toxins by converting the compounds to an intermediate form that can then be processed by Phase II enzymes. Phase II detoxification involves a system in which enzymes further modify the toxins through conjugation with various cosubstrates. There are several known detoxification pathways in the liver used to conjugate toxins: (1) glutathione conjugation, (2) amino acid conjugation, (3) methylation, (4) sulfation, (5) sulfoxidation, (6) acetylation, and (7) glucoronidation.

Glutathione conjugation involves the conjugation of the tripeptide glutathione, made up of cysteine, glutamic acid, and glycine. Glutathione binds to fat-soluble toxins and converts them to a water-soluble form, allowing the kidneys to excrete the bound toxins more efficiently. In amino acid conjugation, an amino acid binds and neutralizes toxins. Methylation involves conjugating a methyl group to toxins. Most methyl groups are donated from S-adenosylmethionine (SAM). Sulfation involves conjugating a sulfur-containing compound to toxins. Sulfoxidation involves the process whereby the enzyme, sulfite oxidase, metabolizes sulfites to sulfates, which are then excreted in the urine. Acetylation involves conjugating acetyl CoA to toxins. Glucuronidation involves the combining of glucuronic acid with toxins.

With respect to the food product, all foodstuff fit for consumption by an individual (and particularly including a human and a pet) are considered suitable for use in conjunction with the teachings presented herein. For example, where the intended consumer of the food is a dog or a cat, all known dog or cat foodstuffs are contemplated, and especially preferred foodstuffs including dried, canned, and/or freshly prepared animal treats. Where the intended consumer of the food animal is a human, all food types (e.g., snack, meal-on-the-go, full-size lunch or dinner, etc.) normally ingested by humans are contemplated.

To distinguish food products from nutritional supplements, the term “food product” is used herein in a limited sense to include only those items that are intended to be masticated as opposed to being swallowed, and in which a standard serving size provides at least 5% of the recommended daily intake for the intended consumer. Higher caloric value food products are contemplated to contain at least 10% or even at least 15% of the recommended daily intake for the intended consumer. For humans and larger animals, it is preferred that food products also provide at least 50 Calories (Kcal) per standard serving size, and more preferably at least 100 Calories (Kcal) per standard serving size. Thus, conventional pharmaceutical preparations such as tablets, lozenges are not contemplated herein because those preparations are usually intended to be swallowed whole, or drunk, or contain insufficient caloric value.

Of course the standard serving size may vary widely depending upon which type of animal is considered to be the target (i.e. intended) consumer. For example, where the food product is an animal treat, the standard serving size may be a small, medium or large dog biscuit. On the other hand, where the food product is cat food, the standard serving size may be a can (e.g., holding approximately 180 g of cat food).

Nutritional supplements for improper liver and digestive function have been previously suggested, including silymarin and betaine. However, it should be appreciated that silymarin has not been suggested to reduce or eliminate bad breath. Similarly, betaine has been suggested to improve bad breath in humans, but there appear to be no suggestions that betaine should be combined with substantial amounts of any other compound for that purpose. Furthermore, it appears that none of the compounds suggested for use in liver toxicity in humans have been suggested to have a desirable effect on bad breath in animals. It is also thought that silymarin and betaine have not been added to food products (as defined herein) in sufficient quantities to significantly improve bad breath.

The active ingredients contemplated herein to prevent or resolve bad breath can be present in food products in any suitable forms, and the names used herein for active ingredients are to be considered broadly to include all forms of the ingredients having a concentration of at least 5% active component. Thus, the term “silymarin” includes silymarin in isolated or synthetic form, silybinin, and silymarin contained in silymarin extracts. Silybinin is a component of silymarin, and typically constitutes 60-90% of silymarin. Active ingredient also includes covalently bound ligands. The term “glutathione” refers herein to glutathione in reduced or oxidized form, or conjugated with other substances. As another example betaine may advantageously be included as betaine HCL.

Contemplated food products include at least one of the active ingredients in an amount effective to significantly reduce bad breath, more preferably at least two such active ingredients, and even more preferably at least three such active ingredients. By the term “improving” or “significantly reduce bad breath” is meant reducing volatile sulfur compounds in breath of the consuming individual in by at least 10%. More preferred reductions are at least 20%, at least 30%, at least 50%, and at least 75%. These reductions are measured in a single measurement after at least one standard serving of the food product has been ingested on a daily basis for a week. There are numerous known methods of measuring volatile sulfur compounds (VSC) in breath, and all of the known methods are contemplated to be suitable for use herein. However, an especially preferred method includes gas chromatographic separation and quantification of the VSCs. Especially contemplated VSCs include hydrogen sulfide, mercaptomethane, and mercaptoethane.

As used herein, the term “mg/kg” refers to weight in milligrams (mg) of compound per body weight in kilograms (kg) of the target (i.e. intended) consumer.

A standard serving size may advantageously include at least 0.5 mg of silymarin, although more preferable amounts are at least 5 mg, 50 mg, 100 mg, and 400 mg. In terms of mg/kg of body weight of the consumer, a standard serving size preferably includes at least 0.15 mg/kg, and more preferably at least 2 mg/kg, 10 mg/kg, 35 mg/kg, and 60 mg/kg of silymarin.

Furthermore, a standard serving size may advantageously include at least 0.5 mg of betaine, although other contemplated amounts include all amounts between about 5 mg and about 400 mg. In terms of mg/kg of body weight of the consumer, a standard serving size preferably includes at least 0.15 mg/kg, and preferably fall within the range of at least 6 mg/kg to at least 60 mg/kg.

Still further, a standard serving size may advantageously include at least 1 mg of glutathione, although other contemplated amounts include all amounts between about 10 mg and about 500 mg. In terms of mg/kg of body weight of the consumer, a standard serving size preferably includes at least 1.4 mg/kg, and preferably fall within the range of at least 0.15 mg/kg to at least 60 mg/kg.

Contemplated antioxidants include ascorbic acid, alpha-tocopherol, astaxanthin, beta-carotene, and a green tea extract. A standard serving size may advantageously include at least 1 mg of antioxidants, although other contemplated amounts include all amounts between about 10 mg and about 500 mg. In terms of mg/kg of body weight of the consumer, a standard serving size preferably includes at least 0.15 mg/kg, and preferably fall within the range of at least 6 mg/kg to at least 60 mg/kg.

Contemplated methyl donors include betaine and S-adenosylmethionine. A standard serving size may advantageously include at least 0.5 mg of methyl donors, although other contemplated amounts include all amounts between about 0.75 mg and about 400 mg. In terms of mg/kg of body weight of the consumer, a standard serving size preferably includes at least 0.15 mg/kg, and preferably falls within the range of at least 6 mg/kg to at least 60 mg/kg.

Contemplated sulfur group donors include methionine, cysteine, taurine, ethanethiosulfate, and sodium thiosulfate. A standard serving size may advantageously include at least 0.5 mg of sulfur donors, although other contemplated amounts include all amounts between about 5 mg and about 60 mg. In terms of mg/kg of body weight of the consumer, a standard serving size preferably includes at least 0.15 mg/kg, and preferably fall within the range of at least 6 mg/kg to at least 60 mg/kg.

In a particularly preferred aspect, the food product comprises a standard serving size (approximately 400 g (about 13.2 oz)) of standard dog chow (e.g., comprising sufficient water for processing, poultry by-products, meat by-products, chicken, sunflower oil, citrus pectin, minerals, guar gum, sodium tripolyphosphate, carrageenan, yam flour, tetra potassium pyrophosphate, caramel coloring, xanthan gum, natural flavors, onion powder, garlic powder, yellow #5, and yellow #6). The dog chow further comprises powdered milk thistle extract standardized to 300 mg of silymarin (e.g., commercially available from TwinLab®) and 500 mg reduced glutathione (e.g., commercially available from Jarrow Formulas), 200 mg of an antioxidant, 300 mg of a methyl group donor, 100 mg of a sulfur group donor, and 100 mg of acetyl CoA as active ingredients. The amounts of these ingredients are effective to reduce volatile sulfur compounds in breath of a dog in an amount of at least 10% when the food serving is administered to the dog.

From a method standpoint, it is contemplated to market a food product using the steps of: (a) identifying a standard serving size on a packaging of the food product; (b) including in the serving size of the food at least 10 mg of silymarin, 10 mg of betaine, or a combination thereof, (c) at least one of an antioxidant, glutathione, a methyl group donor, a sulfur group donor, acetyl CoA, or glucuronic acid; and (c) advertising the product as a treatment of bad breath.

Preferred methods advertise food products in which the standard serving size has a caloric value of at least 50 Calories, and more preferably at least 100 Calories. The advertising is preferably directed towards treating bad breath in humans or pets, especially dogs or cats. In the advertising, which may occur in the labeling on the packing of a food product, the antioxidant is preferably selected from the group consisting of ascorbic acid, alpha-tocopherol, astaxanthin, beta-carotene, and a green tea extract. The methyl group donor is preferably selected from the group consisting of betaine and S-adenosylmethionine. The sulfur group donor is preferably selected from the group consisting of methionine, cysteine, taurine, ethanethiosulfate, and sodium thiosulfate. Advertising is still more preferred where a serving size of the food product includes at least 10 mg each of at least two or three of the active ingredients. Most preferred is where a serving size of the food product is advertised as including significant quantities of silymarin and betaine. Contemplated combinations include at least 10 mg of each of silymarin and betaine, more preferably at least 100 mg of each, and even more preferably at least 300 mg of each per standard serving.

It should also be appreciated that advertising may specify that the food product is useful for improving liver function, digestions, skin color, and/or periodontal health. Advertising may be performed in all known manners, and particularly includes providing a printed instruction on the product, providing an informative brochure, and broadcasting via television, Internet, and so forth.

Thus, a food product may advantageously be labeled as providing the following in a standard service size for a target consumer: (a) calories equivalent to at least 5% of a recommended daily caloric intake; (b) at least 0.15 mg/kg of silymarin, at least 0.15 mg/kg of betaine, or a combination thereof; and (c) at least 0.2 mg/kg of an antioxidant; glutathione, a methyl group donor, a sulfur group donor, acetyl CoA, or glucuronic acid.

The food products may be labeled as providing calories equivalent to at least 10% of the recommended daily caloric intake in the standard serving size. The antioxidant, methyl group donors and sulfur group donors are preferably as described elsewhere herein.

Thus, specific embodiments and applications of methods and products for bad breath have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of marketing a food product comprising:
identifying a standard serving size on a packaging of the food product;
including in the serving size of the food at least 10 mg of silymarin, at least 10 mg of betaine, or a combination thereof;
at least one of at least 10 mg of an antioxidant, at least 10 mg of glutathione, at least 10 mg of a methyl group donor, at least 1 mg of a sulfur group donor, at least 10 mg of acetyl CoA, or at least 10 mg of glucuronic acid; and
advertising the product as a treatment of bad breath.

2. The method of claim 1, wherein the standard serving size has a caloric value of at least 50 Calories.

3. The method of claim 1, wherein the standard serving size has a caloric value of at least 100 Calories.

4. The method of claim 1, wherein the step of advertising is directed towards treating bad breath in a human.

5. The method of claim 1, wherein the step of advertising is directed towards treating bad breath in a pet.

6. The method of claim 5, wherein the pet is a dog.

7. The method of claim 1, wherein the antioxidant is selected from the group consisting of ascorbic acid, alpha-tocopherol, astaxanthin, beta-carotene, and a green tea extract.

8. The method of claim 1, wherein the methyl group donor is selected from the group consisting of betaine and S-adenosylmethionine.

9. The method of claim 1, wherein the sulfur group donor is selected from the group consisting of methionine, cysteine, taurine, ethanethiosulfate, and sodium thiosulfate.

10. The method of claim 1, further comprising including in the serving size of the food product at least 10 mg each of at least two of the active ingredients.

11. The method of claim 10, wherein the included active ingredients comprise at least 250 mg of silymarin and at least 250 mg of betaine.

12. The method of claim 1, further comprising including in the serving size of the food product at least three compounds including 10 mg of silymarin.

13. A food product labeled as providing the following in a standard service size for a target consumer:
calories equivalent to at least 5% of a recommended daily caloric intake;
an amount of at least 0.15 mg/kg of silymarin, 0.15 mg/kg of betaine, or a combination thereof; and
at least 0.2 mg/kg of an antioxidant, glutathione, a methyl group donor; a sulfur group donor, acetyl CoA, or glucuronic acid.

14. The food product of claim 13, wherein the food product is labeled as providing calories equivalent to at least 10% of the recommended daily caloric intake in the standard serving size.

15. The food product of claim 13, wherein the antioxidant is selected from the group consisting of ascorbic acid, alpha-tocopherol, astaxanthin, beta-carotene, and a green tea extract, wherein the methyl group donor is selected from the group consisting of betaine and S-adenosylmethionine, and wherein the sulfur group donor is selected from the group consisting of methionine, cysteine, taurine, ethanethiosulfate, and sodium thiosulfate.

16. The food product of claim 13, wherein the standard serving size of the food product includes at least 0.15 mg/kg of silymarin and at least 0.15 mg/kg of betaine.

17. The food product of claim 13, wherein the standard serving size of the food product includes at least 6 mg/kg of silymarin and at least 6 mg/kg of betaine.

18. The food product of claim 13, wherein the standard serving size of the food product includes at least 50 mg/kg of silymarin and at least 50 mg/kg of betaine.

19. The food product of claim 13, wherein the labeling includes a description of the food product as an animal treat.

20. The food product of claim 13, wherein the labeling includes advertising of the product for improving liver function.

21. The food product of claim 13, wherein the labeling includes advertising of the product for improving digestion.

22. The food product of claim 13, wherein the labeling includes advertising of the product for improving periodontal health.
